(19) United States
(12) Patent Application Publication
(10) Pub. No.: US 2013/0226788 A1
(43) Pub. Date: Aug. 29, 2013

(54) Payment Account Management

(71) Applicants: Michael Donikian, Seattle, WA (US); Amit Bhosle, Bellevue, WA (US); Ammar Chinoy, Seattle, WA (US); Ashish Agrawal, Seattle, WA (US); Jeffrey D. Hatfield, Newcastle, WA (US); Gurbinder S. Gill, Seattle, WA (US); Kurt Kufeld, Seattle, WA (US)

(72) Inventors: Michael Donikian, Seattle, WA (US); Amit Bhosle, Bellevue, WA (US); Ammar Chinoy, Seattle, WA (US); Ashish Agrawal, Seattle, WA (US); Jeffrey D. Hatfield, Newcastle, WA (US); Gurbinder S. Gill, Seattle, WA (US); Kurt Kufeld, Seattle, WA (US)

(73) Assignee: AMAZON TECHNOLOGIES, INC., Reno, NV (US)

(21) Appl. No.: 13/407,912

(22) Filed: Feb. 29, 2012

(51) Int. Cl. G06Q 40/00

(52) U.S. Cl. 705/39

(57) ABSTRACT

Disclosed are various embodiments for charging one or more accounts based on user-created business rules for transactions that occur on a master account. The transaction management application identifies the master account associated with the charge request. Once the master account has been identified, the transaction management application determines which of the other accounts to charge or debit for the charge request.

### BACKGROUND

There are many different types of credit cards available today. Each offers different features and benefits such as, for example, low interest, minimal fees, airline miles, and/or other credit card rewards. Therefore, many consumers have multiple credit card accounts. Managing multiple credit cards involves monitoring when each of the credit card payments are due, tracking reward points for each of the credit cards, evaluating varying interest rates for each of the credit cards, tracking expiration dates for each of the credit cards, and/or other credit card management activities.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a drawing of an example of a user interface rendered by a client in the networked environment of FIG. 1 according to various embodiments of the present disclosure.

FIG. 3 is a flowchart illustrating one example of functionality implemented as portions of transaction management application executed in a computing environment in the networked environment of FIG. 1 according to various embodiments of the present disclosure.

FIG. 4 is a schematic block diagram that provides one example illustration of a computing device employed in the networked environment of FIG. 1 according to various embodiments of the present disclosure.

### DETAILED DESCRIPTION

The present disclosure relates to charging one or more accounts based on user-created business rules for transactions that occur on a master account. Various embodiments of the present disclosure facilitate creation of business rules for charging one or more accounts based one or more charge transactions associated with a payment instrument that corresponds to a master account. For example, the payment instrument may comprise a credit card, a debit card, a gift card, and/or other type of card.

As an example, a user of a payment instrument initiates a transaction at a point-of-sale system. The payment instrument is swiped, scanned or otherwise entered at a point-of-sale system that generates a charge request and sends the charge request to the transaction management application. A charge request may include, for example, a purchase, a cash advance, and/or other transaction description of goods made by a user of the payment instrument. The transaction management application identifies the master account associated with the charge request. The transaction management application determines one or more of accounts to charge for the charge request based on business rules established by the user of the payment instrument. The transaction management application charges an amount specified in the charge request to one or more of the accounts. In the following discussion, a general description of the system and its components is provided, followed by a discussion of the operation of the same.

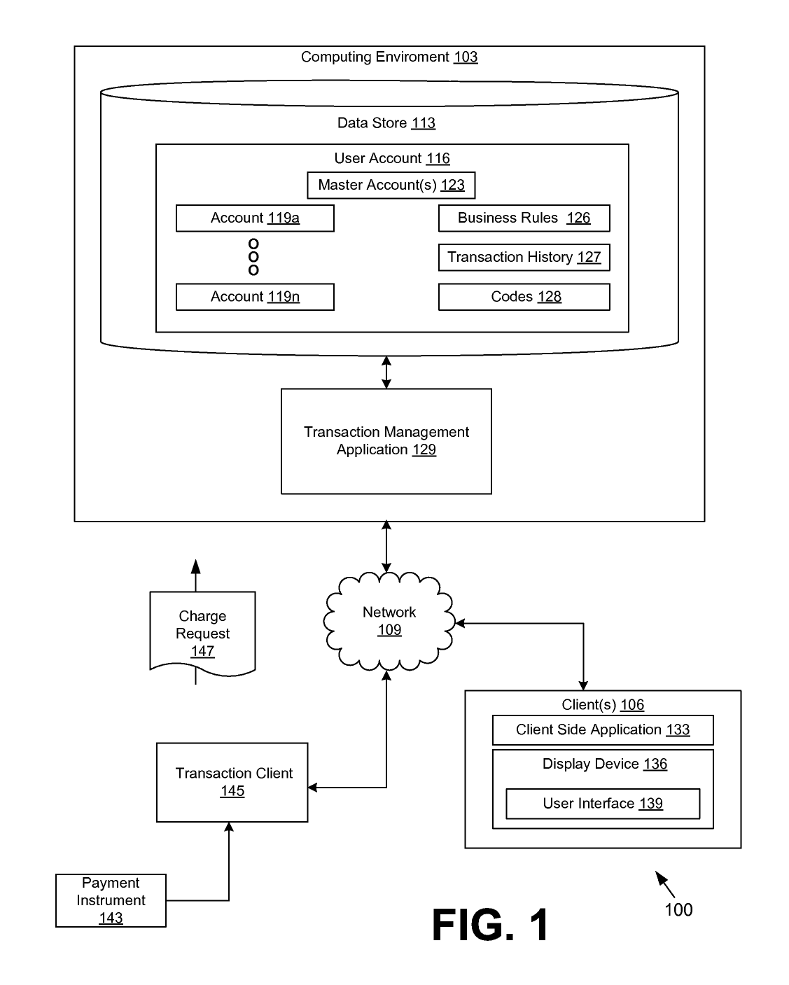

With reference to FIG. 1, shown is a networked environment 100 according to various embodiments. The networked environment 100 includes a computing environment 103 in data communication with one or more clients 106 by way of a network 109. The network 109 includes, for example, the Internet, intranets, extranets, wide area networks (WANs), local area networks (LANs), wired networks, wireless networks, or other suitable networks, etc., or any combination of two or more such networks.

The computing environment 103 may comprise, for example, a server computer or any other system providing computing capability. Alternatively, the computing environment 103 may comprise a plurality of servers or other computing devices that are arranged, for example, in one or more server banks or computer banks or other arrangements. For example, the computing environment 103 may comprise a cloud computing resource, a grid computing resource, and/or any other distributed computing arrangement. The computing environment 103 may be located in a single installation or may be distributed among many different geographical locations.

Various applications and/or other functionality may be executed in the computing environment 103 according to various embodiments. Also, various data is stored in a data store 113 that is accessible to the computing environment 103. The data store 113 may be representative of a plurality of data stores as can be appreciated. The data stored in the data store 113, for example, is associated with the operation of the various applications and/or functional entities described below.

The components executed on the computing environment 103, for example, include a transaction management application 129, and other applications, services, processes, systems, engines, or functionality not discussed in detail herein. The transaction management application 129 is executed to facilitate creation and implementation of business rules for charging one or more transaction accounts based one or more charge transactions associated with a master account. The transaction management application 129 may communicate with the client 106 over various protocols such as, for example, hypertext transfer protocol (HTTP), simple object access protocol (SOAP), user datagram protocol (UDP), transmission control protocol (TCP), and/or other protocols for communicating data over the network 109.

The data stored in the data store 113 includes, for example, user account 116, a plurality of accounts 119a . . . 119n, master account 123, business rules 126, transaction history 127, codes 128 and potentially other data. User account 116 comprises data about the user of the client 106 that is authorized to make charge transactions using master account 123. Such user account 116 may include information such as, usernames, passwords, security credentials, authorized applications, and/or other data. Accounts 119 may be associated with a single master account 123. Accounts 119 identify the particular account which may be charged, debited or credited when a purchase, a cash advance, and/or other transaction is made by an authorized user of the master account 123. For example, accounts 119 may comprise a credit card account, a debit card account, a store value account, a gift card account, and/or other account.

Business rules 126 may include data that may be configured by a user of the master account 123 that is accessed by the transaction management application 129 in selecting one or more of the accounts 119 to charge when a purchase, a cash advance, and/or other transaction is made by a user of the master account 123. Business rules 126 includes user-created business rules used to identify one or more accounts 119 to charge for transactions made by a user of a master account 123. For example, a user may require as part of the business rules 126 that a particular one of the accounts 119 is charged only in a specific location, a specific store or group of stores, or for a specific purpose.

The master account 123 may also include a transaction history 127. The transaction history 127 includes information relating to the transactions associated with the master account 123. For example, the transaction history 127 may provide a record of the purchases, cash advances, and other transactions associated with the master account 123. Additionally, the transaction history 127 may include a breakdown of all of the past charges associated with each of the accounts 119 thereby allowing a user to track all purchases and/or expenses in a single location.

Codes 128 serve as a mechanism to secure access to information or prevent/enable transactions associated with the master account 123. For example, when an authorized user of the master account 123 wishes to access information relating to the master account 123, the user may enter codes 128 such as a password, a personal identification (PIN) code, an account code, name, number, and/or other form of identifying information associated with securing the master account 123. Codes 128 may be used by a user of the payment instrument 143 to pay bills, check account balances, transfer funds, or perform a variety of other account transactions.

The client 106 is representative of a plurality of client devices that may be coupled to the network 109. The client 106 may comprise, for example, a processor-based system such as a computer system. Such a computer system may be embodied in the form of a desktop computer, a laptop computer, a personal digital assistant, a cellular telephone, web pads, tablet computer systems, game consoles, or other devices with like capability.

The client 106 may be configured to include client side application 133, display devices 136, user interface 139 and/or other applications. The client side application 133 may be executed in a client 106, for example, to access and render network pages, such as web pages, or other network content served up by the computing environment 103 and/or other servers. In this respect, the client side application 133 may comprise a browser or other applications. The client 106 may be configured to execute applications beyond client side application 133 such as, for example, email applications, instant message applications, and/or other applications. The client application 133 may include graphical information that is employed, for example, to generate one or more user interfaces 139 that are rendered on the display device 136 of the client 106 in order to enable a user that manipulates such client 106 to interact with transaction management application 129 as will be described.

The client side application 133 is executed to allow a user to interact with transaction management application 129 executed in the computing environment 103. To this end, the client side application 133 is configured to receive input provided by the user and send this input over the network 109 to the computing environment 103 as business rules 126 or other data. In one embodiment, the client side application 133 comprises a plug-in within a browser application. The client 106 may include a display device 136 and may also include one or more input devices. Such input devices may comprise, for example, devices such as keyboards, mice, joysticks, accelerometers, light guns, game controllers, touch pads, touch sticks, push buttons, optical sensors, microphones, webcams, and/or any other devices that can provide user input.

Payment instrument 143 may correspond to a credit card, a debit card, a gift card, a radio frequency identification (RFID) device, and/or other instrument used for making transactions. Payment instrument 143 is associated with the master account 123. For example, the payment instrument 143 may be used to access different accounts 119 associated with different financial institutions. Alternatively, the payment instrument 143 may be used to access multiple accounts 119 associated with the same financial institution. The transaction client 145 is used to scan/read payment instrument 143 and generate a charge request 147. The transaction client 145 may include, for example, a register, a credit card scanner, a credit card reader, an RFID checkout system, an electronic commerce system, a point-of-sale system, and/or any other system used in processing transactions involving goods and services. A charge request 147 may include for example, purchases of items, refunds, cash advances, and/or other transactions made by a user of payment instrument 143.

Next, a general description of the operation of the various components of the networked environment 100 is provided. To begin, a user employs a payment instrument 143 at a transaction client 145. The transaction client 145 scans the payment instrument 143 and generates a charge request 147 in association with a given transaction such as a purchase, a refund, a cash advance, and/or other transactions made by a user of payment instrument 143. Upon receipt of the charge request 147, the transaction client 145 transmits the charge request 147 to the transaction management application 129. The transaction management application 129 identifies the master account 123 in the charge request 147. The transaction management application 129 accesses the business rules 126 in order to determine one or more of the accounts 119 to charge for the charge request 147.

As an example, a user employing a client 106 manipulates the client side application 133 to enter information in the data store 113 that corresponds to the business rules 126. In one embodiment, a user may designate one or more specific transaction categories to be included in business rules 126 such as, entertainment, dining, shopping, utilities, etc. Upon receipt of the charge request 147 from the transaction client 145, the transaction management application 129 identifies the master account 123 listed in the charge request 147. Once the master account 123 has been identified by the transaction management application 129, the transaction management application 129 accesses the business rules 126 to identify one or more of the accounts 119 which may be debited or credited when a purchase, a cash advance, and/or other transaction is made by a user of the payment instrument 143 for the charge request 147. The transaction management application 129 charges or credits an amount specified in the charge request 147 to one or more of the accounts 119.

In one embodiment, a user employing a client 106 may specify a type of merchant as part of the business rules 126 to be used by the transaction management application 129 in determining which of the accounts 119 to charge for the charge request 147. For example, a user employing a client 106 may specify types of merchants such as retail, computer, hardware, plumbing, etc. to be included in the business rules 126. Each transaction involving a respective type of merchant may be charge to one or more of the accounts 119.

In another embodiment, a user employing a client 106 may create business rules that direct the transaction management application 129 to use the location of origin as part of the business rules 126 to be accessed by the transaction management application 129 in determining which of the accounts 119 to charge for the charge request 147.

In yet another embodiment, a user employing a client 106 may designate a user-defined priority order based at least in part on the personal preferences of the user for charging each of the accounts 119 associated with the master account 123. For example, the user of the payment instrument 143 may specify a random preference order in the business rules 126 to be used in determining which of the accounts 119 which may be debited or credited when a purchase, a cash advance, and/or other transaction is made by a user of the payment instrument 143 for the charge request 147.

In one embodiment, a user may designate that the accounts 119 to be charged according to the each of corresponding available credit limits associated with each of the accounts 119. The transaction management application 129 may track each of the available credit limits associated with each of the accounts 119. Additionally, the transaction management application 129 may send an alert to a client 106 when one or more of the accounts 119 have reached the corresponding available credit limit. In one embodiment, the transaction management application 129 determines whether the amount specified in the charge request 147 exceeds the respective credit limit associated with the corresponding account 119, the transaction management application 129 may charge the amount to any other accounts 119. In another embodiment, the transaction management application 129 determines a total credit amount for the master account 123 by aggregating each of the available credit limits associated with each of the accounts 119. For example, a user employing a client 106 may include in the business rules 126 that the accounts 119 that have the highest available credit amount to be charged first. Alternatively, a user employing a client 106 may include in the business rules 126 that the accounts 119 that have the lowest available credit amount to be charged first. As another example, a user employing a client 106 may include in the business rules 126 that the accounts 119 that have the lowest interest rate be charged first. A user may also include in the business rules 126 that the accounts 119 that offer the most reward points be charged. In still another embodiment, a user may specify that either a minimum number of charge requests 147 or maximum number of charge requests 147 are charged or debited to a respective one of the accounts 119.

In one embodiment, the transaction management application 129 accesses the transaction history 127 associated with the master account 123. The transaction history 127 includes information relating to the transactions associated with the master account 123. For example, the transaction history 127 may provide a record of the purchases, cash advances, and other transactions associated with the master account 123. The transaction management application 129 may render on a display device 136 of a client 106 product recommendations to a user of the payment instrument 143 based on the transaction history 127. In this respect, the transaction management application 129 may present recommendations to a user employing a client 106 relating to products, goods, services, merchants, and/or other recommendations that are similar to products, goods, services, merchants, and/or other goods and services maintained in the transaction history 127.

In another embodiment, the transaction management application 129 may encode for display on the display device 136 of a client 106 the account management recommendations to a user of the payment instrument 143 based on the transaction history 127. In this respect, the transaction management application 129 may generate account management recommendations by employing business rules or other approaches. Such recommendations might suggest a change to respective accounts that would allow a user to maximize rewards points associated with one or more accounts 119, take advantage of a low interest rates associated with one or more accounts 119, and/or obtain some other advantage set forth in the account management recommendations.

The transaction management application 129 may utilize one or more codes 128 to access information relating to the master account 123. As an example, codes 128 can be used by a user to freeze all accounts 119 associated with the master account 123 in order to prevent an unauthorized user from making transactions with the payment instrument 143.

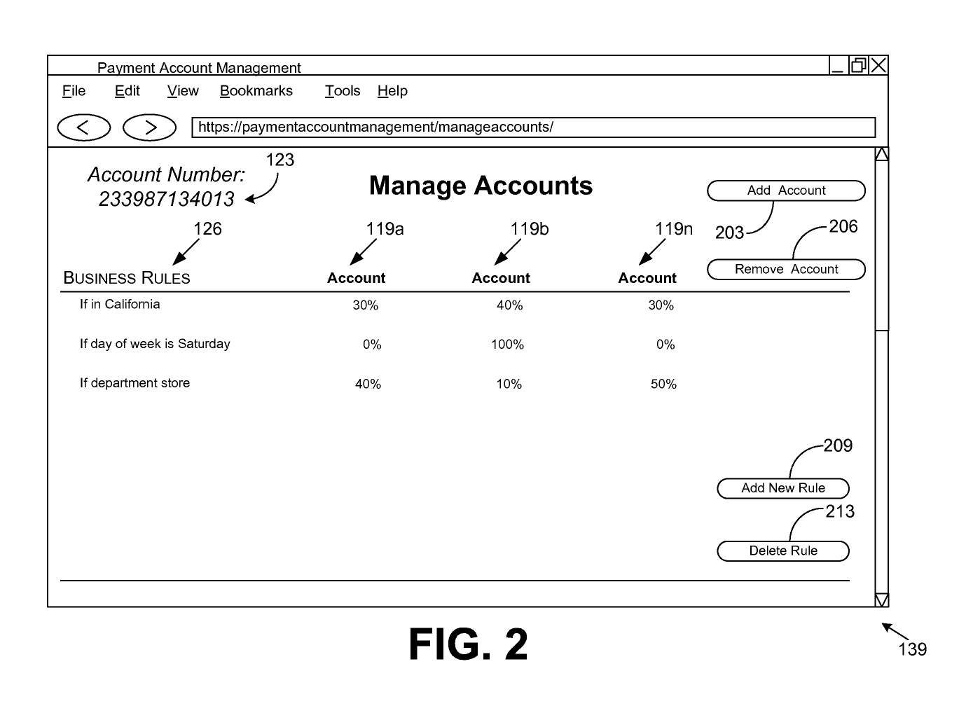

Referring next to FIG. 2, shown is one example of a user interface 139 according to various embodiments. The user interface 139 is rendered, for example, on a display 136 (FIG. 1) associated with a respective client 106 (FIG. 1) upon execution of the client side application 133 (FIG. 1). In one embodiment, the user interface 139 depicts the business rules 126 (FIG. 1) associated with each of the accounts 119 (FIG. 1). In one embodiment, in order to manipulate the components of the user interface 139, a user may “click” one of the components depicted in the user interface 139 by positioning a cursor over a given component and manipulating a button on a mouse associated with a client 106. Alternatively, other approaches may be used to manipulate the various buttons, icons, or other components of the user interface 139 as can be appreciated.

For example, a user may interact with the transaction management application 129 to add, store, and/or display one or more of the accounts 119. A user may add an account 119 by “clicking” on the “add account” button 203, whereupon further user interfaces may be presented to facilitate adding a new account 119. Alternatively, other approaches may be employed to add additional accounts 119. Such approaches may involve the selection of boxes and buttons to cause an account 119 to be added. As another example, a user may delete a selected one of the accounts 119 by selecting the account 119 to be removed and “clicking” the “remove account” button 206. The accounts 119 may also be deleted in some other manner.

Similarly, a user may interact with the transaction management application 129 to create, store, and/or display one or more of the business rules 126 associated with the master account 123. A user may add a business rule 126 by “clicking” on the “add new rule” button 209 whereupon further user interfaces may be presented to facilitate the addition of a new business rule 126. Alternatively, other approaches may be employed to create business rules 126. Such approaches may involve the selection of boxes and buttons to cause a business rule 126 to be created. Also, text boxes may be filled in with various parameters to define a rule. Additionally, a user may delete a selected one of the business rules 126 by selecting the business rule 126 to be removed and “clicking” the “delete rule” button 213. The business rules 126 may also be deleted in some other manner.

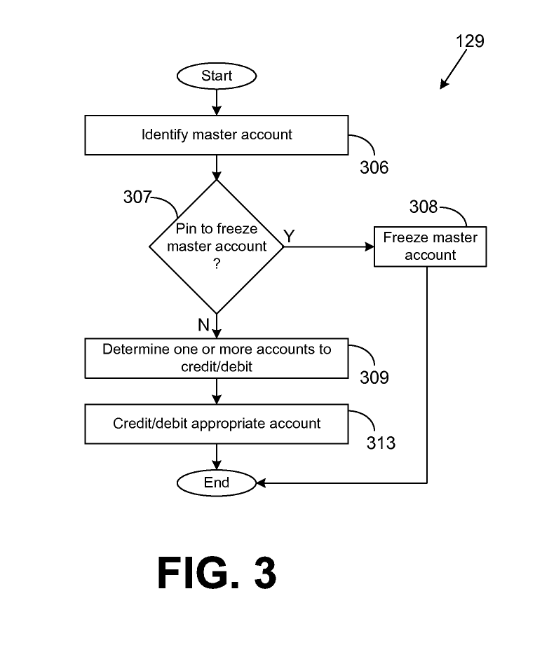

Referring next to FIG. 3, shown is a flowchart that provides one example of the operation of a portion of the transaction management application 129 that is implemented to manage one or more accounts 119 associated with a master account 123 through user-defined business rules according to various embodiments. It is understood that the flowchart of FIG. 3 provides merely an example of the many different types of functional arrangements that may be employed to implement the operation of the portion of the transaction management application 129 as described herein. As an alternative, the flowchart of FIG. 3 may be viewed as depicting an example of steps of a method implemented in the computing environment 103 (FIG. 1) according to one or more embodiments.

Beginning with box 306, when a user desires to use a payment instrument 143 (FIG. 1) for purchases and other transactions at a transaction client 145 (FIG. 1), the transaction client 145 scans the payment instrument 143 and sends at charge request 147 (FIG. 1) to the transaction management application 129. Upon receipt, the transaction management application 129 identifies the master account 123 (FIG. 1) listed in the charge request 147 received from a transaction client 145. In box 307, the transaction management application 129 determines if a pin code 128 (FIG. 1) associated with freezing the master account 123 is included in the charge request 147 or other message. Assuming that the code 128 has been received, the transaction management application 129 proceeds to box 308 and freezes the master account 123 to prevent access to accounts 119. Otherwise, the transaction management application 129 moves to box 309.

In box 309, the transaction management application 129 determines one or more of the accounts 119 (FIG. 1) to charge or debit for the charge request 147. In one embodiment, the transaction management application 129 determines one or more of the accounts 119 to charge or debit based on a transaction category associated with the charge request 147. For example, a user employing a client 106 may designate that specific transaction categories such as, entertainment, dining, shopping, utilities, etc. be charged to designated ones of the accounts 119. The transaction management application 129 may determine based on the transaction category associated with the charge request 147 one or more of the accounts 119 which may be debited or credited when a purchase, a cash advance, and/or other transaction is made by a user of the payment instrument 143.

In yet another embodiment, a user employing a client 106 may specify a type of merchant as part of the business rules 126 to be used by the transaction management application 129 in determining which of the accounts to charge for the charge request 147. For example, a user employing a client 106 may specify types of merchants such as, retail, computer, hardware, plumbing, etc. Each transaction involving a respective type of merchant may be charged to one or more of the accounts 119.

In another embodiment, a user employing a client 106 may create business rules that direct the transaction management application 129 to use the location of origin of the charge request 147 in determining which of the accounts 119 to charge for the charge request 147. Each of the transactions occurring in a specific city, a particular state, a specific country, and/or other geographic region which may be defined by a user employing a client 106 as part of the business rules 126 may be charged to one or more of the accounts 119.

In another embodiment, a user employing a client 106 may designate a user-defined priority order based on the personal preferences of the user for charging each of the accounts 119 associated with the master account 123. In box 313, once the transaction management application 129 has determined which of the accounts 119 to charge or debit for the charge request, the transaction management application 129 charges the appropriate accounts 119. Thereafter, the transaction management application ends.

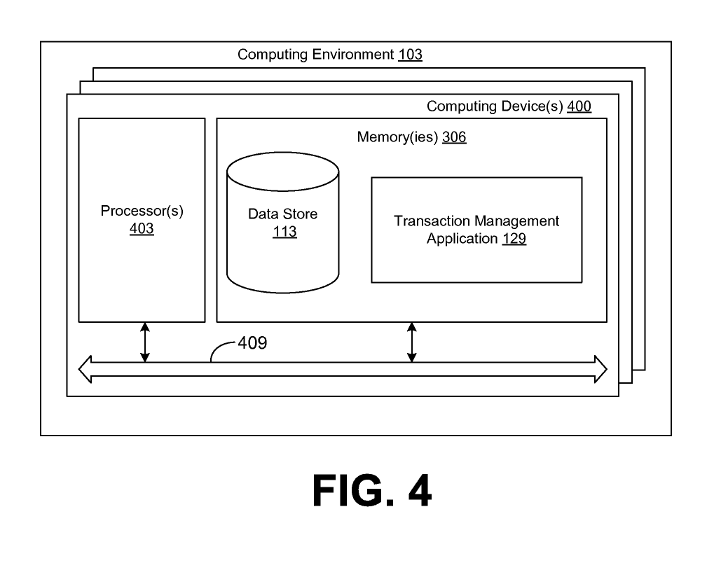

With reference to FIG. 4, shown is a schematic block diagram of the computing environment 103 according to an embodiment of the present disclosure. The computing environment 103 includes one or more computing devices 400. The computing device 400 includes at least one processor circuit, for example, having a processor 403 and a memory 306, both of which are coupled to a local interface 409. To this end, the computing environment 103 may comprise, for example, at least one server computer or like device. The local interface 409 may comprise, for example, a data bus with an accompanying address/control bus or other bus structure as can be appreciated.

Stored in the memory 406 are both data and several components that are executable by the processor 403. In particular, stored in the memory 406 and executable by the processor 403 are transaction management application 129, and potentially other applications. Also stored in the memory 406 may be a data store 113 and other data. In addition, an operating system may be stored in the memory 406 and executable by the processor 403.

It is understood that there may be other applications that are stored in the memory 406 and are executable by the processors 403 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 406 and are executable by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 406 is defined herein as including both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 403 may represent multiple processors 403 and the memory 406 may represent multiple memories 406 that operate in parallel processing circuits, respectively. In such a case, the local interface 409 may be an appropriate network 109 (FIG. 1) that facilitates communication between any two of the multiple processors 403, between any processor 403 and any of the memories 406, or between any two of the memories 406, etc. The local interface 409 may comprise additional systems designed to coordinate this communication, including, for example, performing load balancing. The processor 403 may be of electrical or of some other available construction.

Although transaction management application 129, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 3 shows the functionality and operation of an implementation of portions of the transaction management application 129. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 403 in a computer system or other system. The machine code may be converted from the source code, etc. If embodied in hardware, each block may represent a circuit or a number of interconnected circuits to implement the specified logical function(s).

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. Further, in some embodiments, one or more of the blocks shown in FIG. 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including transaction management application 129, that comprises software or code can be embodied in any non-transitory computer-readable medium for use by or in connection with an instruction execution system such as, for example, a processor 403 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A non-transitory computer-readable medium embodying a program executable in a computing device, the program comprising:
code that identifies a master account in at least one charge request received from a transaction client;
code that determines at least one of a plurality of linked accounts to charge for the charge request based on at least one of a plurality of rules;
code that causes at least a portion of an amount specified in the charge request to be charged to the at least one of the linked accounts;
code that determines a cumulative available credit amount from a plurality of available credit amounts, wherein individual available credit amounts are associated with the linked accounts;
code that determines a transaction history associated with the master account; and
code that determines a plurality of recommendations based on the transaction history.

2. The non-transitory computer-readable medium of claim 1, wherein the code determines the at least one of the linked accounts to charge for the charge request is based at least in part on a user-defined account priority.

3. The non-transitory computer-readable medium of claim 1, wherein the amount specified in the charge request exceeds the available credit amount associated with a respective one of the linked accounts, the amount charged being divided among the plurality of linked accounts.

4. A system, comprising:
at least one computing device;
a master account stored in a memory accessible to the at least one computing device;
a transaction history associated with the master account;
a plurality of linked accounts associated with the master account stored in the memory;
a plurality of predefined rules associated with the master account; and
a transaction management application executable in the at least one computing device, the transaction management application comprising:
logic that, in response to receiving a charge request from a transaction client, identifies the master account listed in the charge request;
logic that determines at least one of the linked accounts to charge for the charge request based on at least one of the predefined rules;
logic that causes at least a portion of an amount specified in the charge request to be charged to the at least one of the linked accounts, wherein a total amount charged to the at least one of the linked accounts equals the amount specified in the charge request; and
logic that determines a plurality of recommendations based at least in part on the transaction history.

5. The system of claim 4, wherein the transaction management application further comprises logic that determines an aggregate credit amount from a plurality of available credit limits, wherein each of the available credit limits is associated with a corresponding one of the linked accounts.

6. The system of claim 5, wherein the master account has a total credit limit that corresponds to the available credit limits that have been aggregated.

7. The system of claim 5, wherein the transaction management application further comprises logic that tracks each of the available credit limits associated with each of the linked accounts.

8. The system of claim 5, wherein the transaction management application further comprises logic that sends an alert to a client when at least one of the available credit limits is reached.

9. The system of claim 4, wherein the transaction management application further comprises logic that tracks a reward account, wherein the reward account is associated with one of the linked accounts.

10. The system of claim 4, wherein the transaction management application further comprises a plurality of codes associated with the master account.

11. The system of claim 10, wherein at least one of the codes initiates a freezing of the master account.

12. (canceled)

13. The system of claim 4, wherein the recommendations are product recommendations.

14. The system of claim 4, wherein the recommendations are account management recommendations.

15. The system of claim 4, wherein the transaction management application further comprises logic that generates at least one user interface that facilitates interaction with the transaction management application, the at least one user interface being configured for rendering for display on a display device of a client.

16. A method, comprising the steps of:
storing a master account in a memory accessible to at least one computing device;
storing a plurality of secondary accounts in the memory, wherein the plurality of secondary accounts are associated with the master account;
storing a plurality of predefined rules in the memory, wherein the plurality of rules are associated with the master account;
determining a plurality of recommendations based at least in part on a transaction history associated with the master account;
receiving, via at least one computing device, a charge request associated with the master account from a transaction client;
determining, via at least one computing device, one of the secondary accounts to charge for the charge request; and
causing, in the at least one computing device, an amount specified by the charge request to be charged to one of the secondary accounts.

17. The method of claim 16, further comprising the step of determining, in the at least one computing device, a transaction category associated with the charge request.

18. The method of claim 17, wherein the step that determines the secondary account further comprises determining, in the at least one computing device, the secondary account based at least in part on the transaction category.

19. The method of claim 16, further comprising the step of determining, in the at least one computing device, a type of merchant associated with the charge request.

20. The method of claim 19, wherein the step that determines the secondary account further comprises the step of determining, in the at least one computing device, the secondary account based at least in part on the type of merchant.

21. The method of claim 16, further comprising the step of determining, in the at least one computing device, a location of origin associated with the charge request.

22. The method of claim 21, wherein the step that determines the secondary account further comprises the step of determining, in the at least one computing device, the secondary account based at least in part on the location of origin.
